(19) United States
(12) Patent Application Publication
(10) Pub. No.: US 2014/0287829 A1
(43) Pub. Date: Sep. 25, 2014

(54) APPARATUS AND METHOD FOR DETECTING ABNORMAL ACCOUNT

(71) Applicant: Myeong Jin Yun, Seoul (KR)

(72) Inventor: Myeong Jin Yun, Seoul (KR)

(73) Assignee: Neople, Inc.

(21) Appl. No.: 14/351,536

(22) PCT Filed: Dec. 14, 2011
(86) PCT No.: PCT/KR2011/009624

§ 371 Date: Apr. 11, 2014

(30) Foreign Application Priority Data
Oct. 13, 2011 (KR) 10-2011-0104797

(51) Int. Cl. A63F 13/30

(52) U.S. Cl. CPC A63F 13/12
USPC 463/29

(57) ABSTRACT

An apparatus and method are provided, for detecting at least one relevant account related to an abnormal account detected in a game and control the at least one relevant account.

### TECHNICAL FIELD

The present invention relates to an apparatus and method for detecting an abnormal account, and more particularly, to an apparatus and method for detecting a relevant account in a top-down manner from an abnormal account.

### BACKGROUND ART

Nowadays, an online game market is increasing drastically. According to this tendency, various game companies are investing a great deal of time and effort in development of online games. Consequently, the online games are developing in not only quantity but also quality.

Through the online games, a user may experience a society in cyber space, where economic activities are performed just as in actual life, using items and game goods used by a character corresponding to the user.

For example, the user of the online game may decorate or reinforce the character by obtaining the items and the like using the character. In addition, the user may purchase items necessary for the character by obtaining the game goods. Also, the user may sell the items obtained to purchase the game goods.

These days, however, the user may purchase game goods with actual money and obtain game goods easily by applying the game goods purchased with actual money. Furthermore, conversely, the user may sell the game goods obtained through the online game to other users by receiving actual money.

Recently, a social problem is arising in that some users prepare a dedicated large-scale computer to obtain items and game goods professionally through online games and sell the items and game goods for actual money.

### DISCLOSURE OF INVENTION

### Solution to Problem

According to an aspect of the present invention, there is provided an abnormal account detection apparatus including a first detection unit to detect an abnormal account in a game, a second detection unit to detect at least one relevant account related to the abnormal account, and an account control unit to control the abnormal account and the at least one relevant account.

The first detection unit may detect the abnormal account that obtains game goods in the game illegally.

The first detection unit may detect the abnormal account that sells game goods in the game, illegally, through a game goods trading site.

The second detection unit may determine, as the at least one relevant account, at least one other account that obtained game goods of an amount greater than or equal to a predetermined reference amount from the abnormal account.

The second detection unit may determine, as the at least one relevant account, at least one other account that transmitted game goods of an amount greater than or equal to a predetermined reference amount to the abnormal account.

The second detection unit may inspect transaction data between the abnormal account and the at least one other account and, when game goods are traded at a price less than or equal to a predetermined reference, determines the at least one other account as the at least one relevant account.

The second detection unit may detect at least one other relevant account related to the at least one relevant account, a predetermined number of times.

According to another aspect of the present invention, there is provided an abnormal account detection method including detecting an abnormal account in a game, detecting at least one relevant account related to the abnormal account, and controlling the abnormal account and the at least one relevant account.

### BRIEF DESCRIPTION OF DRAWINGS

These and/or other aspects, features, and advantages of the invention will become apparent and more readily appreciated from the following description of exemplary embodiments, taken in conjunction with the accompanying drawings of which:

FIG. 1 is a block diagram illustrating a structure of an abnormal account detection apparatus according to an embodiment of the present invention;

FIG. 2 is a flowchart illustrating a method for detecting an abnormal account, according to an embodiment of the present invention;

FIGS. 3 and 4 are flowcharts illustrating a method for detecting and controlling an abnormal account, according to an embodiment of the present invention;

FIG. 5 is a diagram illustrating an example of log data resulting from detection of an abnormal account, according to an embodiment of the present invention; and

FIGS. 6 and 7 are diagrams illustrating an administrator mode of an abnormal account detection apparatus, according to an embodiment of the present invention.

### MODE FOR THE INVENTION

Reference will now be made in detail to exemplary embodiments of the present invention, examples of which are illustrated in the accompanying drawings. In the following description, when it is determined that a detailed description of well-known functions related to the present invention and the construction thereof would make the gist of the present invention obscure, they will be omitted for conciseness and ease of description. The terminology used herein is for the purpose of describing particular embodiments only and the definition may be varied according to the intention of a user, an operator, or customs. Therefore, the terms and words should be defined based on a description of this specification. Like reference numerals refer to the like elements throughout.

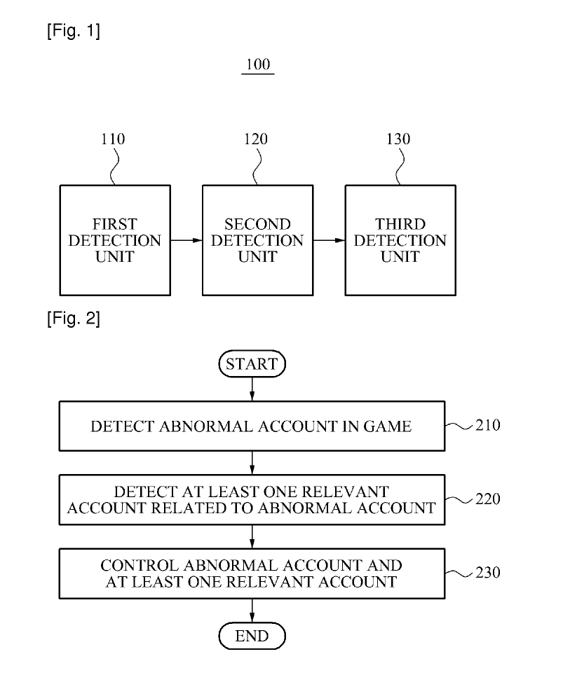

FIG. 1 is a block diagram illustrating a structure of an abnormal account detection apparatus 100 according to an embodiment of the present invention.

Referring to FIG. 1, the abnormal account detection apparatus 100 may include a first detection unit 110 for detecting an abnormal account in a game, a second detection unit 120 for detecting at least one relevant account related to the abnormal account, and an account control unit 130 for controlling the abnormal account and the at least one relevant account.

The abnormal account detection apparatus 100 may detect a certain user selling game goods abnormally, for example, changing game goods into actual money through a game goods trading site. In this case, the account detection apparatus 100 may determine an account of the corresponding user to be an abnormal account.

The user of the abnormal account may obtain the game goods in an abnormal manner, that is, using a large number of game accounts through an illegal program, and may collect the game goods in a small number of accounts and sell the game goods to other users.

The abnormal account detection apparatus 100 may detect the abnormal account by searching for a path of collecting the game goods, and detect relevant accounts related to the detected abnormal account, collectively.

Hereinafter, a method of detecting an abnormal account according to an embodiment of the present invention will be described.

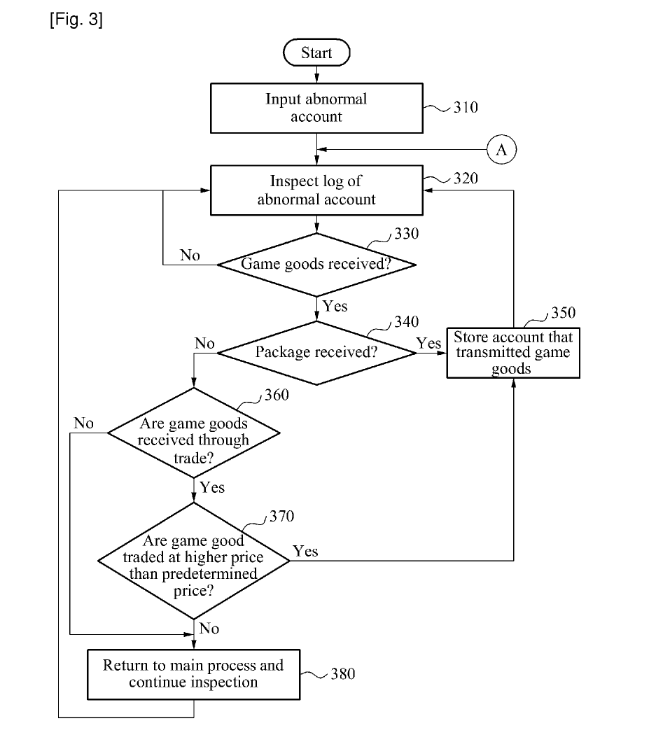

FIG. 2 is a flowchart illustrating a method for detecting an abnormal account, according to an embodiment of the present invention.

Referring to FIG. 2, in operation 210, the abnormal account detection apparatus 100 may detect the abnormal account in the game using the first detection unit 110.

The first detection unit 110 may detect the abnormal account that obtains game goods illegally in the game.

When at least one account is detected as an account selling at least one item of the game goods a predetermined number of times or more, the first detection unit 110 may determine the at least one account to be the abnormal account.

The first detection unit 110 may inspect transaction data between the at least one account and at least one other account and, when the game goods are traded at a price less than or equal to a predetermined reference price, the first detection unit 110 may determine the at least one account and the at least one other account to be the abnormal accounts.

When the at least one account repeats the same pattern, the first detection unit 110 may determine the at least one account to be the abnormal account.

The first detection unit 110 may detect the abnormal account that sells the game goods illegally in the game through a game goods trading site.

In operation 220, the abnormal account detection apparatus 100 may detect, using the second detection unit 120, at least one relevant account related to the abnormal account.

The second detection unit 120 may determine at least one other account that obtained game goods of an amount greater than or equal to a predetermined reference amount from the abnormal account, to be the at least one relevant account.

The second detection unit 120 may determine at least one other account that transmitted game goods of an amount greater than or equal to the predetermined reference amount to the abnormal account, to be the at least one relevant account.

Generally, the game goods are sent in the form of a game package in the game and are seldom handed over in large quantities.

When the game goods of an amount greater than or equal to the predetermined reference amount is transmitted to or received from the abnormal account through a game package function, the second detection unit 120 may consider a user of the corresponding account to be identical to a user of the relevant account related to the corresponding account, and accordingly detect both accounts as the abnormal accounts.

The second detection unit 120 may inspect transaction data between the abnormal account and at least one other account and, when the game goods are traded at a price less than or equal to a predetermined reference price, may determine the at least one other account to be the at least one relevant account.

Normally, users of the game, who trade game goods amongst themselves, would not continue an unbalanced trade relationship.

For example, generally, when exchanging the game goods in the game, the users suggest the game goods to be exchanged with each other and approve the trade when the trade is considered reasonable.

When an uneven trade is performed, the second detection unit 120 may determine that users are acquaintances or one user is trading the game goods using a plurality of accounts.

In trading of the game goods between the abnormal account and the at least one other account, when the abnormal account trades the game goods at 1/N of a price suggested by a user of the at least one other account and obtains N times as much profit or more, the second detection unit 120 may detect the at least one other account that accepted such a trade as also being the abnormal account.

The second detection unit 120 may register a second abnormal account as the relevant account detected through the abnormal account. In addition, the second detection unit 120 may detect a relevant account related to the second abnormal account, that is, in a top-down manner, thereby further detecting relevant accounts.

The second detection unit 120 may detect at least one other relevant account related to the at least one relevant account, by repeating the detection operation a predetermined number of times.

Thus, by repeating operation 220, the abnormal account detection apparatus 100 may detect other relevant accounts with respect to the relevant account, thereby detecting a plurality of relevant accounts related to the abnormal account.

In operation 230, the abnormal account detection apparatus 100 may control the abnormal account and the at least one relevant account using the account control unit 130.

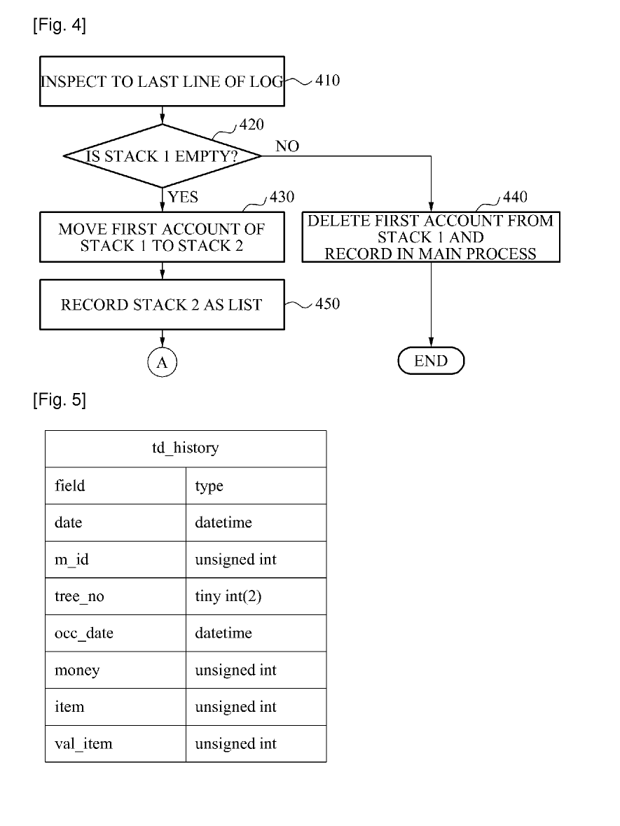

Hereinafter, a method of detecting and controlling an abnormal account according to an embodiment of the present invention will be described with reference to FIGS. 3 and 4.

FIGS. 3 and 4 are flowcharts illustrating a method for detecting and controlling an abnormal account, according to an embodiment of the present invention.

The abnormal account detection apparatus 100 may input an identifier (ID) of the abnormal account in operation 310, and inspect log data of the abnormal account line by line for a predetermined duration in operation 320.

The abnormal account detection apparatus 100 may determine whether the abnormal account received game goods from at least one other account in operation 330, and determine whether the game goods are received through a game package in operation 340.

When the abnormal account received the game goods through the game package, in operation 350, the abnormal account detection apparatus 100 may store information on the at least one other account that transmitted the game goods to a stack 1 of the log data and then return to operation 320.

When the game goods received by the abnormal account are not the game goods received through the game package, in operation 360, the abnormal account detection apparatus 100 may determine whether the abnormal account received the game goods through a trade with at least one other account.

When the abnormal account received the game goods through the trade, in operation 370, the abnormal account detection apparatus 100 may determine whether the game goods are traded at a price higher than a predetermined reference price.

When the trade is performed at a price higher than the predetermined reference price, in operation 350, the abnormal account detection apparatus 100 may store information on the at least one other account that transmitted the game goods to a stack 1 of the log data and return to operation 320.

When the game goods received by the abnormal account are not the game goods received through the trade or are not the game goods traded at a price higher than the predetermined reference price, in operation 380, the abnormal account detection apparatus 100 may return to a main process and continue inspection of the log data.

After the abnormal account detection apparatus 100 completes the inspection up to a last line of the log data of the abnormal account in operation 410, the abnormal account detection apparatus 100 may determine whether the stack 1 is empty in operation 420.

When the stack 1 is empty, the abnormal account detection apparatus 100 may move an ID of a first account of the stack 1 to a stack 2 in operation 430, and delete the first account from the stack 1 while recording the ID, a current account order, and the like in the main process in operation 440.

When the stack 1 is not empty, the abnormal account detection apparatus 100 may retain the stack 2 as a list and end the process, in operation 450.

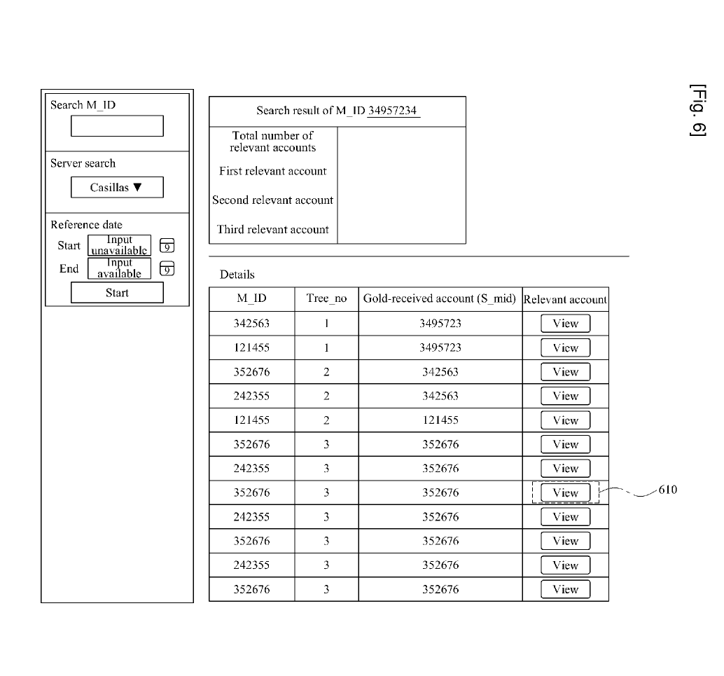

FIG. 5 is a diagram illustrating an example of log data resulting from detection of an abnormal account, according to an embodiment of the present invention.

Referring to FIG. 5, the abnormal account detection apparatus 100 may generate and store log data for analyzing a pattern that provides an abnormality score.

The abnormal account detection apparatus 100 may store, as the log data, a current date (date), an account transmitting the game goods (m_id), a current account order (tree_no), an account receiving the game goods (s_mid), date and time of receiving the game goods (occ_date), scale of the game goods (money), an ID corresponding to the game goods (item), an average price of the game goods (val_item), and the like.

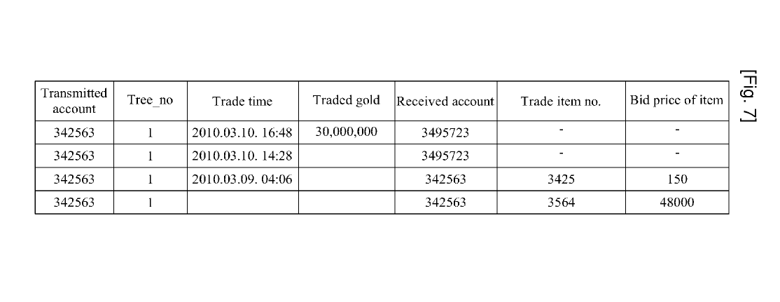

FIGS. 6 and 7 are diagrams illustrating an administrator mode of an abnormal account detection apparatus, according to an embodiment of the present invention.

The abnormal account detection apparatus 100 may detect the relevant accounts related to the abnormal account from a first account to a third account and provide a process for an administrator to recognize game money, for example gold, and a related log as shown in FIG. 6.

The administrator of the abnormal account detection apparatus 100 may click a view button 610 to inspect details as shown in FIG. 7.

According to the embodiments of the present invention, relevant accounts of an abnormal account may be detected and controlled collectively.

According to the embodiments of the present invention, unfair trades performed by a person who sells game goods for actual money and a hacker may be tracked.

According to the embodiments of the present invention, an economy of the game may be stabilized, thereby increasing reliability of game users with respect to the game.

The above-described embodiments of the present invention may be recorded in non-transitory computer-readable media including program instructions to implement various operations embodied by a computer. The media may also include, alone or in combination with the program instructions, data files, data structures, and the like. The program instructions recorded on the media may be those specially designed and constructed for the purposes of the embodiments, or they may be of the kind well-known and available to those having skill in the computer software arts. Examples of non-transitory computer-readable media include magnetic media such as hard disks, floppy disks, and magnetic tape; optical media such as CD ROM discs and DVDs; magneto-optical media such as optical discs; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be configured to act as one or more software modules in order to perform the operations of the above-described embodiments of the present invention, or vice versa.

Although a few exemplary embodiments of the present invention have been shown and described, the present invention is not limited to the described exemplary embodiments. Instead, it would be appreciated by those skilled in the art that changes may be made to these exemplary embodiments without departing from the principles and spirit of the invention, the scope of which is defined by the claims and their equivalents.

1. An abnormal account detection apparatus comprising:
a first detection unit to detect an abnormal account in a game;
a second detection unit to detect at least one relevant account related to the abnormal account; and
an account control unit to control the abnormal account and the at least one relevant account.

2. The abnormal account detection apparatus of claim 1, wherein the first detection unit detects the abnormal account that obtains game goods in the game illegally.

3. The abnormal account detection apparatus of claim 1, wherein the first detection unit detects the abnormal account that sells game goods in the game illegally through a game goods trading site.

4. The abnormal account detection apparatus of claim 1, wherein the second detection unit determines, as the at least one relevant account, at least one other account that obtained game goods of an amount greater than or equal to a predetermined reference amount from the abnormal account.

5. The abnormal account detection apparatus of claim 1, wherein the second detection unit determines, as the at least one relevant account, at least one other account that transmitted game goods of an amount greater than or equal to a predetermined reference amount to the abnormal account.

6. The abnormal account detection apparatus of claim 1, wherein the second detection unit inspects transaction data between the abnormal account and the at least one other account and, when game goods are traded at a price less than or equal to a predetermined reference price, determines the at least one other account as the at least one relevant account.

7. The abnormal account detection apparatus of claim 1, wherein the second detection unit detects at least one other relevant account related to the at least one relevant account, a predetermined number of times.

8. The abnormal account detection method comprising:
detecting an abnormal account in a game;
detecting at least one relevant account related to the abnormal account; and
controlling the abnormal account and the at least one relevant account.

9. The abnormal account detection method of claim 8, wherein the detecting of the abnormal account comprises detecting the abnormal account that obtains game goods in the game illegally.

10. The abnormal account detection method of claim 8, wherein the detecting of the abnormal account comprises detecting the abnormal account that sells game goods in the game illegally through a game goods trading site.

11. The abnormal account detection method of claim 8, wherein the detecting of the at least one relevant account comprises determining, as the at least one relevant account, at least one other account that obtained game goods of an amount greater than or equal to a predetermined reference amount from the abnormal account.

12. The abnormal account detection method of claim 8, wherein the detecting of the at least one relevant account comprises determining, as the at least one relevant account, at least one other account that transmitted game goods of an amount greater than or equal to a predetermined reference amount to the abnormal account.

13. The abnormal account detection method of claim 8, wherein the detecting of the at least one relevant account comprises:
inspecting transaction data between the abnormal account and the at least one other account; and
determining the at least one other account to be the at least one relevant account when game goods are traded at a price less than or equal to a predetermined reference price.

14. The abnormal account detection method of claim 8, wherein the detecting of the at least one relevant account comprises detecting the at least one other relevant account related to the at least one relevant account, a predetermined number of times.

15. A non-transitory computer readable recording medium storing a program to cause a computer to implement the method of claim 8.
